(19) United States
(12) Patent Application Publication
(10) Pub. No.: US 2003/0105685 A1
(43) Pub. Date: Jun. 5, 2003

(54) System and method for adjusting transactiion length in an automated service device

(75) Inventor: Marshall R. Millikan, Suwanee, GA (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 10/004,982

(22) Filed: Dec. 3, 2001

(51) Int. Cl. G06F 17/60

(52) U.S. Cl. 705/30

(57) ABSTRACT

An automated service device and method of use adjusts transaction duration on the automated service device based on queue length to use the automated service device. This optimizes exposure of specific communications that are provided optionally or in addition to the normal service associated with the automated service device. A queue detector determines whether there is a queue to use the automated service device and/or how many in the queue. When customers are waiting to use the automated service device, optional communications are limited in order to limit the amount of time the customer spends on the automated service device. The amount of time the customer spends on the automated service device is thus limited to the time spent on the normal functionality of the automated service device without optional communications or a limited amount of optional communications. The length of queue may be correlated to the length or amount of optional communications provided to the current customer. When there is no queue, the amount of optional communications is not limited.

### BACKGROUND

1. Field of the Invention

The present invention relates generally to automated service systems and, more particularly, to automated service systems that provide communications that are optional to a main function of the automated service system.

2. Background Information

Automated service devices such as ATMs, kiosks, self-checkouts, and the like (collectively termed “self-service devices”), and assisted-service devices such as check-outs and the like are commonplace in and for many types of businesses and locations. In addition to providing transaction-oriented services (collectively termed “throughput”) with regard to the particular type of automated service device, these automated service devices may provide messages, advertisements, data, other services, and the like (collectively termed “optional communications”) to the user. Retailers, manufacturers and the like have found that such optional communications are an effective manner of advertising and/or presenting offers, promotions or the like to consumers since the consumer is “captive” through use of the automated service device.

When there is no queue to use such automated service devices, there is no problem with providing optional communications to a current user. However, a problem with automated service devices that provide optional communications to the current user is optimizing both throughput and optional communication exposures when there is a queue for using such automated service devices. This is especially true when there is a long queue for using such automated service devices. Users typically do not want to wait to use such automated service devices longer than necessary. When optional communications are provided to the current user in addition to throughput, the use of the automated service device time per user increases. This increases the wait time for users in queue. Increased wait time typically translates to increased user frustration.

As stated, it has been found advantageous for retailers, manufacturers, and the like to utilize such automated service devices to provide optional communications to users. It is also, however, advantageous for the user to have a pleasant experience when using or waiting to use the automated service device. The pleasant experience includes a short waiting time to use the automated service device. Thus, there is a need for the automated service device to provide optional communications to users in addition to the normal or main functionality of the automated service device and provide a pleasant experience for the user.

It would thus be advantageous to have an automated service device that alleviates the above-noted shortcomings and/or problems in current automated service devices that provide optional communications.

What is therefore needed is an automated service device that overcomes one or more of the above-mentioned drawbacks. What is particularly needed is an automated service device that implements both a main functionality of the automated service device and providing optional communications for the user in a more effective manner than the prior art.

### SUMMARY

The subject invention is a system and method that automatically adjusts transaction length with regard to a current user in an automated service device. Particularly, the subject invention is an automated service system that automatically adjusts transaction duration for a current user based on queue length to use the automated service device.

Particularly, an automated service device is operative to provide both a main or core function and an optional communication. A queue detector provides data regarding a queue to use the automated service device. When the queue data indicates that there is no queue to use the automated service device, an optional communication is provided to the current user. When the queue data indicates that a threshold queue value has been reached, the optional communication is not provided to the current user. The decision of whether to offer the optional communication may be accomplished at any time during a current user's transaction.

In accordance with an aspect of the subject invention, there is provided a method of operating an automated service device. The method includes the steps of (a) beginning a transaction on the automated service device in connection with a current user; (b) obtaining data regarding a queue of potential users of the automated service device; and (c) determining whether to provide an optional communication to the current user of the automated service device based on the obtained queue data.

In accordance with another aspect of the subject invention, there is provided an automated service system that includes a processor, a queue detector, a display, and memory. The queue detector is in communication with the processor and is operative to obtain data regarding a queue length of potential users of the automated service system. The display is in communication with the processor and is operative to support a transaction on the automated service system by a current user. The memory is in communication with the processor and contains a plurality of program instructions which, when executed by the processor, causes the processor to (i) obtain queue data from the queue detector, and (ii) determine whether to provide an optional communication to the current user based on the obtained queue data.

In accordance with yet another aspect of the subject invention, there is provided an automated service device that includes a storage device, a processor, a display, and a queue detector. The storage device stores an optional communication. The processor is operative to support a main function transaction of the automated service device. The display is in communication with the processor and is operative to show video in support of the main function transaction. The queue detector is in communication with the processor and is operative to obtain data regarding a queue of potential users of the automated service device. The processor is further operative to utilize the obtained queue data to provide the optional communication only when the queue data obtained by the queue detector is below a queue threshold.

### BRIEF DESCRIPTION OF THE DRAWINGS

FIG. 1 is a block diagram of an exemplary checkout terminal embodying the subject invention;

FIG. 2 is a perspective view of an ATM with a current user performing a transaction thereon and a queue of users waiting to use the ATM; and

FIG. 3 is a flowchart of an exemplary manner of operation of the subject invention.

Corresponding reference characters indicate corresponding parts throughout the several views.

### DETAILED DESCRIPTION OF THE INVENTION

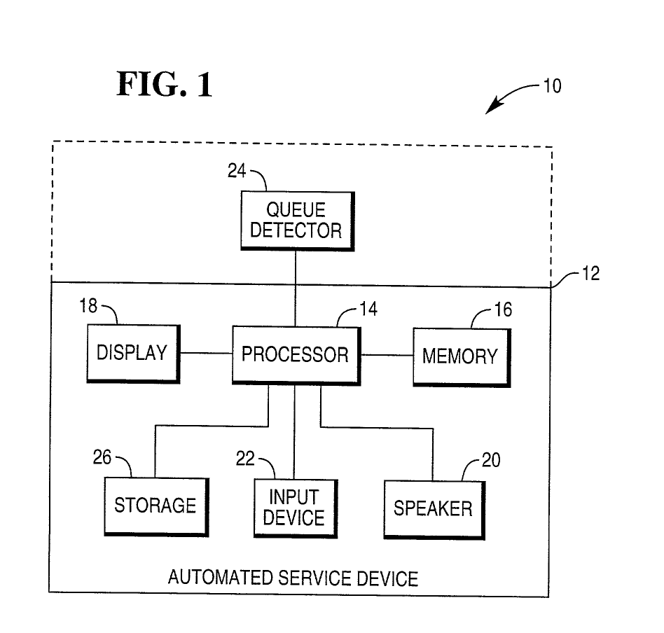

Referring to FIG. 1, there is depicted a block diagram of an exemplary automated service system, generally designated 10, in which the subject invention is embodied. The automated service system 10 includes an automated service device 12 and a queue detector 24. It should be appreciated that the queue detector 24 may or may not physically be part of the automated service device 12 as represented by the dashed line. If the queue detector 24 is physically a part of the automated service detector 12, then the term automated service detector 12 encompasses the queue detector 24. If the queue detector 24 is not physically a part of the automated service detector 12, then the term automated service system 10 encompasses the queue detector (as well as the automated service device 12). The term automated service system 10 in all cases includes the queue detector 24 and the automated service device 12. It should also be appreciated that the automated service device 12 is representative of any type of automated service device such as, without being limiting, a kiosk, a point-of-service (POS) terminal, a retail terminal, an assisted checkout system/terminal, a self-checkout (unassisted) system/terminal, an automated teller machine (ATM), or the like. As such, the automated service device 12 is operative to provide a main service function or main function according to the type of automated service device. For example, a main service function of an ATM is to provide banking services such as dispensing cash, allowing account inquiries, money transfers, and the like. As another example, a main service function of a checkout system/terminal, both assisted and unassisted, is to perform purchase transactions for items. In the case of a kiosk, there may be many main service functions depending on the use of the kiosk. The main service function in all types of automated service devices may consist of one or many portions or functions. The automated service device 12 is also operative to provide an optional communication or optional communications.

The automated service device 12 includes a processor, processor/processing unit, and/or processor/processing logic circuitry (collectively, “processor”) 14 and memory 16 that stores program instructions (software). The program instructions stored in the memory 16 are written and/or operative to carry out or implement the functionality and principles of the subject invention as presented herein. The memory 16 is in communication with the processor 14. The processor 14 is operative to utilize or execute the program instructions stored in the memory 16 in order to implement the functionality of the program instructions. The program instructions, in addition to the processor 14, may also provide control of at least some of the various components of the system 10 as described herein.

The automated service device 12 also includes a display or monitor 18 (or other video reproduction device) that is in communication with the processor 14. The display 18 is operative to provide video information or data as necessary and/or appropriate for the automated service device 12 (i.e. the main service function of the automated service device 12) and the implementation and/or functionality of the subject invention. The display 18 may be any type of video display device as necessary and/or appropriate. The automated service device 12 may include a speaker 20 or other audio reproduction device. The speaker 20 would be in communication with the processor 14 and be operative to provide audio data such as speech and other sounds (indications). An input device 22 is also preferably part of the automated service device 12. The input device would be in communication with the processor 14 and be operative to accept input from a user (user input) as necessary and/or appropriate. This may include the input of a personal identification number (PIN), selections for choices provided by the display 18, or the like.

The automated service device 12 also includes a storage device 26 that is in communication with the processor 14. Preferably, the storage device 26 is dynamic thereby allowing erasing, adding and/or modifying of the content stored thereon. The storage device 26 stores data and/or information regarding necessary and/or appropriate functionality of the automated service device 12. The storage device 26 also stores an optional communication or optional communications for presentation to the display 18 and/or speaker 20. The optional communications may be advertisements, offers for additional or optional services, sign-ups, or the like.

The automated service device 12, utilizing program instructions stored in the memory 16 and executed by the processor 14 is operative to provide an optional communication or optional communications maintained in the storage device 26 to a current user either during a current main service function transaction or after a main service function transaction. The optional communication may consist of video for the display 18 and/or audio for the speaker 20.

The queue detector 24 is in communication with the processor 14 and is operative to detect the presence of a potential user or potential users of the automated service device 12. Particularly, the queue detector 24 is operative to detect whether there is a potential user for the automated service device 12, whether there is a queue (plurality) of potential users for the automated service device 12, and/or a particular number of potential users for the automated service device 12. More particularly, the queue detector 24 is operative to detect and report either that a queue is present or not, the approximate length of the queue, if present, and/or the exact number of people in the queue or length thereof. The queue detector 24 may be any device such as a camera, motion sensor (actuated by heat, light, or other means), or other device. In one form, the queue detector 24 may be weight or pressure sensitive areas of a floor, mat, or the like leading to the automated service detector 24. In another form, the queue detector 24 may be a plurality of light beams and associated light receivers positioned along a path leading to the automated service device 12. The queue detector 24 is thus any device that is operative to detect the presence of a potential user and/or a plurality of potential users forming a line or queue to use the automated service device 12.

In one form, the queue detector 24 is also operative to generate a signal (queue detection signal or queue data) indicative of the detection of a potential user and forward or transmit the queue detection signal to the processor 14. It should be appreciated that a potential user of the automated service device 12 is distinguished from a current user of the automated service device 12. The queue detector 24 is operative and/or positioned so as to detect a potential user of the automated service device 12 rather than a current user of the automated service device 12 since it is the transaction length or duration of the current user that the automated service system 10 may limit in accordance with the principles of the subject invention. Thus, in this case, the current user of the automated service device 12 will not count.

In another form, the queue detector 24 is operative, in addition to detection of a potential user of the automated service device 12, to generate a signal (queue detection signal or queue data) indicative of the detection of a plurality or queue of potential users of the automated service device 12 and/or the approximate number and/or length of the queue of potential users of the automated service device 12, and forward or transmit the queue detection data to the processor 14. In yet another form, the queue detector 24 is operative, in addition to detection of a potential user of the automated service device 12, to generate a signal (queue detection signal or queue data) indicative of the detection of an actual number of potential users in the queue for the automated service device and/or actual length of the queue of potential users for the automated service device, and forward or transmit the queue detection data to the processor 14.

The queue detector 24, if not integral with the automated service device 12, is positioned in a location to detect and report on whether there is a queue of potential users for the automated service device 12 without detecting a current user of the automated service device 12. The queue detector 24 may be located on a pole or other mounting structure, in the ceiling and pointed toward an area where a queue would form, in the floor adjacent an area where a queue would form, at a side area where a queue would form, or other suitable location. The processor 14 is operative to receive the queue detection signal and/or queue data and execute the program instructions stored in the memory 16 pertaining to queue detection and adjustment of the transaction time or user experience on the automated service device 12.

The automated service device 12 receives the input from the queue detector 24 and uses the queue detector input to determine the experience of the current user on the automated service device 12. Particularly, if the queue data from the queue detector 24 indicates that a queue threshold has been reached or exceeded, the optional communication will not be provided to the current user. Else, if the queue data indicates that there is no queue or a small queue that does not reach the queue threshold, the optional communication is provided to the current user. This may be determined at the start of a transaction on the automated service device 12 by a current user, and/or may be determined at the end of a logical transaction (at the end of a portion of a transaction) on the automated service device 12.

The above may be termed “customers in line exceeds threshold”, the logic of which may be expressed by the following example:

If {read queue detector} indicates that “X” customers are in line and “X” >{read threshold parameter} then

Customers exceed threshold=True

Else

Customers exceed threshold=False

In one form, if the queue detector 24 cannot determine length or number of potential users of a queue, a binary true/false may be returned as a result of the above logic, and the supporting program instructions could set the “Customers exceed threshold” flag to the value returned from the queue detector 24.

It should be appreciated that the various components described in connection with the automated service device 10 may not necessarily be the same for each type of automated service device with the exception of the queue detector 22, the software necessary to implement the subject invention, and other components as are necessary to implement the subject invention.

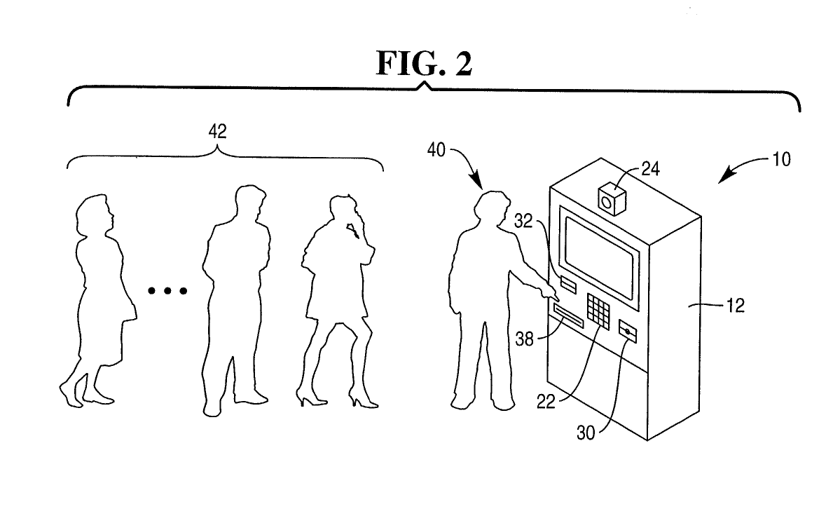

As an illustration of the principles of the subject invention reference is made to FIG. 2. FIG. 2 depicts an automated service system 10 in which the automated service device 12 is an ATM and the queue detector 24 is integral therewith. The ATM includes an input device 22 that is embodied as a keypad. The ATM also includes a card reader 30 that is operative to read information from a smart card, magnetic card, bar-coded card, or the like. A receipt printer 32 is operative to provide a receipt or other printed piece of paper to a current user 40. The ATM further includes a cash dispenser 38 that is operative to provide cash to the current user 40.

The queue detector 24 of the ATM 12 is aimed or positioned to detect a queue 42 and not the current user 40 of the ATM 12. In this particular exemplary embodiment, the queue detector 24 is on the top of the ATM 12 such that the queue detector 24 is above the current user 40. Since there is a queue 42 of potential users, the queue detector 24 would obtain such queue data and thus limit transaction being performed by the current user 40 to the main service function transaction and not provide an optional communication.

The queue threshold may be set by the operator, owner or proprietor of the automatic service device 12 through appropriate program instructions. The queue threshold may also be changed as necessary to suit various needs and/or circumstances. In some cases, the queue threshold may provide for little to no queue, while in other cases the queue threshold may provide for a large queue. The situation, place or type of automated service device may dictate the queue threshold.

Operation

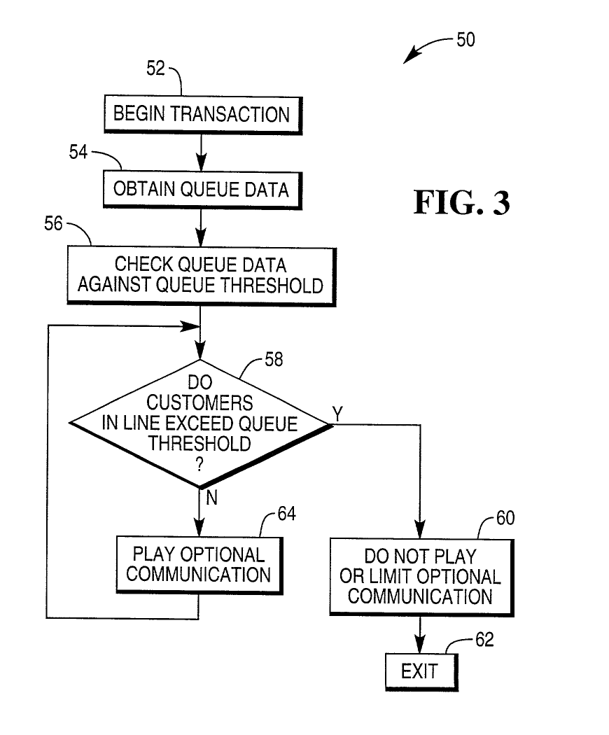

Referring to FIG. 3, there is depicted a flow chart, generally designated 50, of an exemplary manner of operation of an aspect of the subject invention. In particular, there is depicted the flow chart 50 of an exemplary manner of adjusting or limiting transaction duration in an automated service device. It should be appreciated that the manner of operation described below in conjunction with the flow chart 50 is only an example of one manner or mode in which an automated service device 12 may implement the subject invention.

In step 52 a current user begins a transaction on the automated service device. The transaction is a main service function of the automated service device. The transaction may be a first and primary main service function of the automated service device or the transaction may be a second and secondary main service function of the automated service device. In step 54, queue data (data regarding queue length of customers waiting to use the automated service device) from the queue detector is obtained. in step 56, the obtained queue data is compared against the queue threshold.

In step 58, it is determined from the queue data whether the customers in line exceed the queue threshold. Stated another way, the program instructions determine from the queue data whether the number of customers in queue or the length of the queue, whether the queue threshold has either been reached or has been exceeded, in whichever manner the queue threshold has been set. In this example it is whether the queue threshold has been reached. If the queue data indicates that the queue threshold has not been reached (“No”), then in step 64, the optional communication will be played for the current customer. This loop from step 58 to step 64 may be repeated as represented by the arrow until the queue threshold has been reached (“Yes”). If the queue threshold has been reached (“Yes”), then in step 60, the optional communication will not be played. Thereafter, in step 62, there is an exit from the loop.

From the foregoing, the transaction length or duration on the automated service device is limited for the current user by not playing optional or additional communications when there is a particular length of line or queue (or a particular number of people forming the queue) waiting to use the automated service device. Since the optional communications may be played at any time, and a queue may form at any time during a particular transaction including the playing of an optional communication, the automated service device preferably makes the determination of whether to provide optional communication many times during a particular transaction or between different transactions by the same user.

While this invention has been described as having a preferred design, the subject invention can be further modified within the spirit and scope of this disclosure. This application is therefore intended to cover any variations, uses, or adaptations of the subject invention using its general principles. Further, this application is intended to cover such departures from the present disclosure as come within known or customary practice in the art to which this invention pertains and that fall within the limits of the appended claims.

What is claimed is:

1. A method of operating an automated service device comprising the steps of:
beginning a transaction on the automated service device in connection with a current user;
obtaining data regarding a queue of potential users of the automated service device; and
determining whether to provide an optional communication to the current user of the automated service device based on the obtained queue data.

2. The method of claim 1, wherein the step of obtaining data regarding a queue of potential users includes the step of obtaining queue length.

3. The method of claim 1, wherein the step of obtaining data regarding a queue of potential users includes the step of obtaining a number of potential users of the automated service device.

4. The method of claim 1, wherein the step of determining whether to provide an optional communication includes the step of comparing the obtained queue data against a queue threshold.

5. The method of claim 4, further comprising the step of not providing the optional communication when the queue threshold has been reached else providing the optional communication when the queue threshold has not been reached.

6. The method of claim 1, further comprising the step of repeating the steps of obtaining data regarding a queue of potential users of the automated service device and determining whether to provide an optional communication to the current user of the automated service device based on the obtained queue data during various positions in the transaction in connection with the current user.

7. An automated service system comprising:
a processor;
a queue detector in communication with said processor and operative to obtain data regarding a queue length of potential users of the automated service system;
a display in communication with said processor and operative to support a transaction on the automated service system by a current user; and
memory in communication with said processor and containing a plurality of program instructions which, when executed by said processor, causes said processor to:
i) obtain queue data from said queue detector; and
ii) determine whether to provide an optional communication to the current user based on the obtained queue data.

8. The system of claim 7, wherein said memory has further program instructions which, when executed by said processor, causes said processor to obtain queue data from said queue detector regarding queue length.

9. The system of claim 7, wherein said memory has further program instructions which, when executed by said processor, causes said processor to obtain queue data from said queue detector regarding number of potential users of the automated service system.

10. The system of claim 7, wherein said memory has further program instructions which, when executed by said processor, causes said processor to compare the obtained queue data against a queue threshold.

11. The system of claim 10, wherein said memory has further program instructions which, when executed by said processor, causes said processor to not provide the optional communication when the queue threshold has been reached else provide the optional communication when the queue threshold has not been reached.

12. The system of claim 7, wherein said memory has further program instructions which, when executed by said processor, causes said processor to repeat obtaining data regarding a queue of potential users of the automated service device and determining whether to provide an optional communication to the current user of the automated service device based on the obtained queue data during various positions in the transaction in connection with the current user.

13. An automated service device comprising:
a storage device storing an optional communication;
a processor operative to support a main function transaction of the automated service device;
a display in communication with said processor and operative to show video in support of the main function transaction; and
a queue detector in communication with said processor and operative to obtain data regarding a queue of potential users of the automated service device;
the processor being further operative to utilize the obtained queue data to provide the optional communication only when the queue data obtained by said queue detector is below a queue threshold.

14. The automated service device of claim 13, wherein said queue data comprises queue length for use of the automated service device.

15. The automated service device of claim 13, wherein said queue data comprises number of potential users of the automated service device.

16. The automated service device of claim 13, wherein said queue detector is operative to obtain data regarding a queue of potential users of the automated service device at various times during the main function transaction, and said processor is further operative to determine whether to provide the optional communication to the current user of the automated service device at the various times during the main function transaction based on the queue data obtained at the various times during the main function transaction.
